(19) United States
(12) Patent Application Publication
(10) Pub. No.: US 2004/0088921 A1
(43) Pub. Date: May 13, 2004

(54) Gas generator and method for generating a treatment gas, which contains co and h2 for heat treating metallic material

(76) Inventors: Bernd Kleinpass, Ladehofstr (DE); Thomas Mahlo, Geretsried (DE); Reinhard Strigl, Munchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/275,818

(22) PCT Filed: May 5, 2001
(86) PCT No.: PCT/EP01/05092

(30) Foreign Application Priority Data
May 12, 2000 (DE) 10023409.7

(51) Int. Cl. C01B 3/24

(52) U.S. Cl. 48/197 R; 48/119; 48/120; 48/127.9; 48/198.7; 422/188; 422/198; 422/211

(57) ABSTRACT

The invention relates to a gas generator, especially for generating treatment gas containing CO and H₂, for heat treating metallic material at high temperatures. Said gas generator comprises at least one catalytic retort and has means for heating at least partial areas of the catalytic retort(s). According to the invention, the catalytic retort is divided into at least two retort areas (1, 2a, 2b, 2e) and at least one of the retort areas (1), preferably the retort area (1) located first in the direction of flow-through, is configured so that it can be removed from the gas generator. The invention also relates to a method for generating a treatment gas, which contains CO and H₂, for heat treating, especially for carburizing and hardening, metallic material at high temperatures in which the treatment gas is formed on the basis of the catalytic reaction fo a hydrocarbon gas with carbon dioxide, oxygen and/or with a gas mixture containing oxygen, whereby the catalytic reaction is carried out in a catalytic retort. The invention also provides that the catalytic reaction is carried out in a catalytic retort that is divided into at least two retort areas (1, 2a, 2b, 2c).

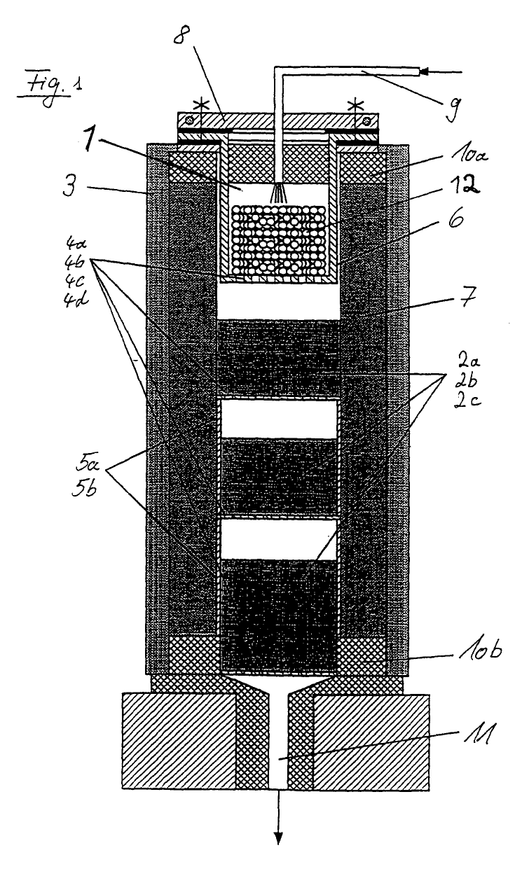

The invention relates to a gas generator, particularly for generating CO- and H₂-containing treatment gas for the thermal treatment of metallic material at high temperatures, having at least one catalyst retort as well as devices for heating at least partial areas of the catalyst retort(s).

The invention also relates to a heat treatment system for implementing the heat treatment method of metallic material at higher temperatures, particularly for implementing carburizing and hardening processes, having at least one gas generator.

Furthermore, the invention relates to a method of generating a CO- and H₂-containing treatment gas for the thermal treatment, particularly the carburizing and hardening, of metallic material at high temperatures, during which the treatment gas is formed on the basis of the catalytic conversion of a carburetted hydrogen gas with carbon dioxide, oxygen and/or an oxygen-containing gas mixture, the catalytic conversion taking place in a catalyst retort. The term “oxygen-containing gas mixture” applies particularly to air as well as to air enriched or downgraded with oxygen.

As a rule, such carburizing and hardening processes of metallic material take place at high temperatures—preferably in the range of from 800 to 1,100° C. However, other thermal treatment processes are carried out at temperatures about 500° C. in atmospheres containing CO- and H₂-containing atmospheres. In this case, the required treatment gas is formed on the basis of the catalytic conversion of a carburetted hydrogen gas (mixture) with carbon dioxide.

It is known to form CO- and H₂-containing protective or reaction gases from air and a carburetted hydrogen gas (mixture)—such as natural gas or propane—by means of a catalytic conversion of the reactive constituents—thus, oxygen and, for example, methane. The typical forming reaction, which represents an incomplete combustion of the carburetted hydrogen gas (mixture), in this case is as follows:

(O₂+4N₂) or (air)+2CH₄→2CO+4H₂+4N₂

This reaction is normally carried out by means of a gas generator which is arranged next to the thermal treatment furnace or furnaces or is mounted directly onto the furnace housing and in its core consists of a catalyst. The so-called endothermic gas formed in the gas generator, as a rule,—optionally also after a cooling step—is supplied without further treatment to the pertaining thermal treatment system. Likewise, it is known to convert the same output gas mixture in a catalyst retort which is arranged in a thermal treatment system and in this manner is already changed to a higher temperature level; see, for example, German Patent Document DE-A 23 63 709 and European Patent Document EP-A 0261 462.

Furthermore, it is known to form CO- and H₂-containing treatment or reaction gases from carbon dioxide and again a carburetted hydrogen gas (mixture), in which case here, as a rule, the protective gas formation is promoted by a catalyst unit. Typical reactions of formation for providing the atmosphere on a CO₂-basis are, for example:

2CO₂+2CH₄→4CO+4H₂

3CO₂+C₃H₈→6CO+4H₂.

These reactions result in atmospheres which, in comparison with the above-mentioned endothermic gas, have clearly increased fractions of carbon monoxide and, in addition, have no nitrogen content. This results in advantages particularly for carburizing processes, specifically in a high carbon transition rate.

From German Patent Document DE-A 199 51 519 (not yet published on the filing date), a method of generating a CO- and H₂-containing reaction or treatment gas is known, in which, instead of the carbon dioxide or, in addition to the carbon dioxide, oxygen is admixed. Even by means of a relatively low and well-apportioned feeding of oxygen, the energy requirement during the generating of treatment gas can clearly be reduced and, in addition, the quality of the forming atmosphere can be maintained, particular with a view to its carburizing effect.

The known gas generators for generating reaction or protective gas atmospheres for the thermal treatment of metals consist of a high-temperature stable metallic retort shell into which the catalytically active material is charged in the form of bulk material. The thus filled catalyst retort is heated up or heated by means of corresponding heating devices from the outside and/or inside and is maintained at the desired operating temperature while the energy supply is continuous.

In industrial thermal treatments, such gas generators generate between approximately 8 and 300 Nm³/h of reaction gas.

However, it is a disadvantage of the known gas generator constructions that the energy or heat feeding into the catalyst retort does not take place selectively. This has the result that certain areas of the catalyst retort are “supplied” with too little energy while, under certain circumstances, too much heat is supplied to other areas of the catalyst retort. Too little heat promotes, for example, the sooting of the catalyst bed—which should best be avoided—because this requires at least a regenerating of the catalyst retort, or the entire retort has to be exchanged. In contrast, too much heat considerably increases the wear and reduces the service life of the retort and of the catalytic material.

Because of the heating of the hydrocarbon constituents in the output gas mixture fed to the catalyst retort, a gradual sooting of the catalyst bed takes place. In order to avoid or slow down this process, a periodic regenerating of the catalyst bed is required—for example, by sweeping the catalyst bed with air, oxygen, CO₂ or other oxygen carriers.

In particular, in the case of newer methods for generating a CO- and H₂-containing treatment gas for the thermal treatment of metallic material—in which also carbon dioxide and/or oxygen is/are supplied to the catalyst—a faster sooting of the catalyst bed will take place because of changed reaction kinematics and a clearly higher energy requirement. This has the result that the used catalyst material has to be exchanged at shorter time intervals.

However, the procedure of exchanging catalyst material requires comparatively high expenditures because, as a rule, the system has to be shut down and the catalyst has to be removed before an exchange of the catalyst material will be possible.

It is an object of the present invention to provide a gas generator for generating a CO- and H₂-containing gas mixture for the thermal treatment, which permits a faster and simpler exchanging of catalyst material and thus minimizes as much as possible the repair and maintenance expenditures. It is also an object of the present invention to provide a method of the above-mentioned type for generating a CO- and H₂-containing treatment gas for the thermal treatment which reduces the formation of soot.

In the case of the gas generator according to the invention, these objects are achieved in that the catalyst retort is divided into at least two retort areas and at least one of the retort areas is constructed to be removable from the gas generator.

The thermal treatment system according to the invention for implementing thermal treatment methods of metallic material at high temperatures, particularly for implementing carburizing and hardening processes, is characterized in that it has at least one gas generator according to the invention.

According to the invention, the catalyst retort is now divided into at least two separate retort areas. In addition, at least one of these retort areas is constructed to be removable from the gas generator. This already permits a faster exchange of sooted catalyst material because now the entire catalyst material no longer first has to be removed from the gas generator before new catalyst material can be charged but only individual retort areas can be or have to be exchanged.

Preferably, at least the retort area which is first in the flow direction is constructed to be removable from the gas generator.

Particularly in this area of the catalyst retort or of the gas generator, particularly in the case of highly endothermic conversion processes with carburetted hydrogen gases, for example, during the reaction of carbon dioxide and methane to predominantly carbon monoxide and hydrogen, a faster sooting may occur so that it is often advantageous for only this area of the catalyst retort to be exchanged (more frequently).

An advantageous further development of the gas generator according to the invention is characterized in that at least the retort area which is first in the flow direction is charged at least partially with a catalytic neutral and/or an at least catalytically less effective material.

Typically, oxide ceramics (such as aluminum oxide and zirconium oxide) can be used as a catalytically neutral material.

The providing of such materials has the result that the soot formation is inhibited in this retort area. The removal of the corresponding retort area from the gas generator is therefore required less frequently.

As a further development of the gas generator according to the invention, it is suggested that the residual charging of the retort area which is filled at least partially with a catalytically neutral and/or an at least catalytically less active material, and/or of the additional retort area or areas consists of a catalytically active material.

A further development of the gas generator according to the invention is characterized in that the devices for heating at least partial areas of the catalyst retort are constructed as heating coils.

The method according to the invention for generating a CO- and H₂-containing treatment gas for the thermal treatment is characterized in that the catalytic conversion takes place in a catalyst retort which is divided at least into two retort areas.

According to an advantageous further development of the method according to the invention, at least the retort area of the catalyst retort which is first in the flow direction is at least partially filled with a catalytically neutral and/or an at least catalytically less active material.

It is particularly advantageous when—corresponding to a further development of the method according to the invention—over the length of the catalyst retort, the heat is fed selectively and in a manner which is adapted to the requirements of the local reaction courses. They energy or heat supply can thus be adapted to the energetic requirements within the catalyst retort—which are oriented according to the composition of the gases to be reacted. As a further development of the gas generator according to the invention, the devices for the heating are therefore constructed to be variable with respect to the heating capacity.

The gas generator according to the invention, the method according to the invention of generating a CO- and H₂-containing treatment gas as well as additional further developments of the latter will be explained in detail by means of the embodiment illustrated in the FIGURE. FIGURE is a longitudinal sectional view of this embodiment of the gas generator according to the invention.

The gas generator according to the invention consists of a preferably cylindrically symmetrically constructed housing 3, of the catalyst retort divided into four areas 1, 2a, 2b and 2c as well as of a heating device 7 which, however, for reasons of clarity, is not shown in detail in the FIGURE. The required heat can be supplied to the reaction space, for example, by a heating device surrounding the reaction space, by one or several heating devices enclosed by catalytically active material, or by a combination of the different heating devices.

The four areas 1, 2a, 2b and 2c of the catalyst retort are arranged above one-another, retort area 1 being the area which is first in the flow direction, retort area 2a being the area which is second in the flow direction, retort area 2b being the area which is third in the flow direction, and retort area 2c being the area which is last in the flow direction.

The heating device 3 is bounded with respect to the upper as well as the lower housing edge by means of insulations 10a and 10b. Furthermore, as required, spacers 5a and 5b between individual retort areas—in the embodiment illustrated in the FIGURE, these are areas 2b and 2c—as well as the heating device 7 are to be provided.

By way of a feed line 9, the input gas mixture, for example, a carburetted hydrogen gas mixture as well as carbon dioxide—is fed to the gas generator. The CO- and H₂-containing gas mixture produced in the catalyst retort is withdrawn by way of the line or the line space 11 from the gas generator. When a greater temperature loss can be avoided, this gas mixture can be fed directly to a thermal treatment space. As an alternative, this gas mixture can rapidly be cooled to temperatures below approximately 200° C., thus can be quenched, without any significant change of the gas mixture.

In the present case, the retort area 1 which is first in the flow direction is arranged in a receptacle 6 which can be removed in its entirety from the gas generator. This receptacle 6 has a gas-permeable bottom 4a. Also the retort areas 2a, 2b and 2c which follow in the flow direction each have a gas-permeable bottom 4b, 4c or 4d. These gas-permeable bottoms 4a to 4d, which ensure a free gas passage, may be constructed, for example, in the shape of a perforated plate.

A catalytically neutral and/or an at least catalytically less active material 1 is arranged in the removable receptacle 6.

In the upward direction, the gas generator according to the invention will be closed off by means of a preferably water-cooled lid system 8. After the removal of this lid system 8, the receptacle 6 can be removed from the gas generator and the catalyst material 1 arranged therein can be exchanged.

The receptacle 6, which can be removed from the gas generator, may consist of a temperature-stable purely metallic, ceramically coated metallic, or a purely ceramic material. The selection of the material of the receptacle 6 as well as of the material 1 arranged therein takes place while taking into account a high temperature stability, a high thermal conductivity and a low catalytic effect at low temperatures, so that the soot formation is inhibited as much as possible.

The feeding of the input gas mixture by way of the line 9 should take place through suitable insulation in the water-cooled lid system 8 such that the fed cold gas mixture—in the case of which no soot formation will occur—enters into a comparatively hot retort area with temperatures of above 800° C., so that the gas mixture is subjected to a heating which is as rapid as possible. Area 2a, in turn, may be constructed of a layering which prevents the arising of very high temperatures of above 1,100° C. Such high temperatures occur particularly when generating endothermic gas from air and methane (natural gas) at a ratio of from approximately 2.5 to 3.0 in that, when the heated output gas mixture comes in contact with the catalytically active mass, an exothermic partial reaction takes place. It is therefore advantageous to build up, directly behind the first catalytically active layer, a catalytically inactive or less active layer of a high temperature stability which is constructed of a material similar to that used in the first retort area 1.

In the area of the retort which is in the rear with respect to the flow direction, the composition of the equilibrium of the protective gas, which is a function of the temperature and the mixture ratios of the output constituents, is set mainly by the reaction

CO₂+H₂ [symbol] H₂O+CO (water gas reaction).

In order to be able to set the process quantity—the carbon dioxide content—, which is important for carburizing-active thermal treatment atmospheres, it may therefore be advantageous to adjust the temperature in this last area in a targeted manner independently of the preceding areas.

It is therefore expedient to feed the heat over the length of the catalyst retort in a selective manner and adapted to the requirements of the local reaction courses.

In addition to the embodiment of the gas generator according to the invention illustrated in the FIGURE, naturally the retort areas 2a, 2b and 2c may also be constructed to be removable from the gas generator.

Furthermore, a vertical arrangement of the gas generator and thus of the catalyst retort, as illustrated in the FIGURE, is expedient because this ensures an optimal and dense pouring of the retort filling(s).

In the case of the gas generator according to the invention as well as the method according to the invention, the soot formation is clearly reduced as a result of the providing of catalytically neutral and/or at least catalytically less active material in the retort area which is first in the flow direction. Because of the faster exchangeability of this material or of the receptacle in which this material is arranged, the removal of sooted material is facilitated and accelerated. The required down times of the gas generator are therefore reduced.

1. Gas generator, particularly for generating CO- and H₂-containing treatment gas for the thermal treatment of metallic material at high temperatures, having at least one catalyst retort as well as devices for heating at least partial areas of the catalyst retort(s), characterized in that the catalyst retort is divided into at least two retort areas (1, 2a, 2b, 2c), and at least one of the retort areas (1) is constructed to be removable from the gas generator.

2. Gas generator according to claim 1, characterized in that at least the retort area (1) which is first in the flow direction is constructed to be removable from the gas generator.

3. Gas generator according to claim 1 or 2, characterized in that at least the retort area (1) which is first in the flow direction is filled at least partially with a catalytically neutral and/or an at least catalytically less active material.

5. (There is no claim 4—translator) Gas generator according to claim 3 or 4, characterized in that the residual filling of the retort area (1), which is filled at least partially with a catalytically neutral and/or at least catalytically less active material, and/or the or the additional retort areas (2a, 2b, 2c) consists of a catalytically active material.

6. Gas generator according to one of the preceding claims, characterized in that the devices for heating at least partial areas of the catalyst retort are constructed as heating coils.

7. Gas generator according to one of the preceding claims, characterized in that the devices for the heating are constructed to be variable with respect to the heating capacity.

8. Thermal treatment system for implementing thermal treatment methods of metallic material at high temperatures, particularly for implementing carburizing and hardening processes, having at least one gas generator, characterized in that the thermal treatment system has at least one gas generator according to one of the preceding claims.

9. Method of generating a CO- and H₂-containing treatment gas for the thermal treatment, particularly the carburizing and hardening, of metallic material at high temperatures, during which the treatment gas is formed on the basis of the catalytic conversion of a carburetted hydrogen gas with carbon dioxide, oxygen and/or an oxygen-containing gas mixture, the catalytic conversion taking place in a catalyst retort, characterized in that the catalytic conversion takes place in a catalyst retort divided into at least two retort areas (1, 2a, 2b, 2c).

10. Method according to claim 9, characterized in that, during the catalytic conversion, at least the retort area (1) of the catalyst retort which is first in the flow direction is filled at least partially with a catalytically neutral and/or an at least catalytically less active material.

11. Gas generator according to claim 9 or 10, characterized in that, over the length of the catalyst retort, heat is supplied in a selective manner and adapted to the requirements of the local reaction courses.
